(19) United States
(12) Patent Application Publication
(10) Pub. No.: US 2023/0038157 A1
(43) Pub. Date: Feb. 9, 2023

(54) System and Method for Laser Cleaning

(71) Applicant: Feng Gao, Chino Hills, CA (US)

(72) Inventor: Feng Gao, Chino Hills, CA (US)

(21) Appl. No.: 17/494,807

(22) Filed: Oct. 5, 2021

(30) Foreign Application Priority Data
Aug. 4, 2021 (CN) 202110888497.5

(51) Int. Cl. B23K 26/402; B23K 26/70; B23K 26/08; B23K 37/00; B23K 26/361

(52) U.S. Cl. CPC B23K 26/402; B23K 26/703; B23K 26/0869; B23K 37/003; B23K 26/361; B23K 2103/30

(57) ABSTRACT

A laser cleaning system includes a laser cleaning device having a laser rubber-removal assembly having a laser generator, a laser ejector connected with the laser generator, and a position adjustor slidably connected with a loading assembly; and a recycling assembly having a vacuum collector communicated with a recycling processing device; wherein the laser ejector is arranged on the loading assembly through the position adjustor; wherein the laser generator is configured to generate laser beams to remove rubber residues and the position adjustor is configured to adjust locations of the laser ejector; wherein the vacuum collector is configured to collect the rubber residues and the recycling processing device is configured to granulate the collected rubber residues.

### FIELD OF THE DISCLOSURE

The present disclosure relates to a laser cleaning system, and more particularly to a laser cleaning system and method which is enabled to not only remove the rubber residues but also to recycle the rubber residues for second uses.

### BACKGROUND OF THE DISCLOSURE

Generally, while the airplanes or flights take off, the tires of the airplanes or flights are in contact with the runway surface at a high speed, so the high-speed friction generated between the tires and the runway surface may cause the high temperature to instantly dissolve the rubber tires into rubber adhesive/residues deposited on the runway. While more and more rubber adhesive/residues deposit on the runway, the frictions of the runway surface may be decreased, and the safety of landing or taking off may be dramatically affected.

One of the commercial ways to remove the rubber adhesive/residues on the runway is mechanical removal. The mechanical removal process involves grinding or milling the runway surface to achieve the removal of rubber deposits. The advantage of mechanical removal is that the runway surface layer and the filler would not be damaged. However, the mechanical removal method utilizes several grinding or milling machines, if the operators are lack experience, the concrete surface and the grooves of the runway may be damaged, and the micro-cracks may be generated. Therefore, the pavement of the runway may need to be redone sooner.

The other one of the commercial ways to remove the rubber adhesive/residues on the runway is chemical removal. This method may comprise steps of spraying the solvent solution on the contaminated area, waiting for some time, and then washing and sweeping. Different chemical agents are used depending on the surface (concrete, asphalt, etc.). However, if the chemical is allowed to remain on the runway surface for too long, the paint and the concrete of the runway surface could be damaged. When washing the cleaning compound off the runway surface, other methods, such as dilution of the cleaning chemical compound, may be applied to avoid the chemical solvent polluting the surrounding vegetation, drainage system, or wildlife.

Another one of the commercial ways to remove the rubber adhesive/residues on the runway is high-pressure water blasting removal. The high-pressure water blasting removal is also a mechanical removal for rubber deposits. The equipment ranges from a single, manually operated nozzle (or gun) supplied by a pump, a water tank, and a high-pressure water spray bar. This equipment generates ultra-high water pressure ranging from 140 to 240 Mpa. It can consistently remove rubber deposits without disturbing the pavement's micro-texture.

However, the high-pressure water blasting removal requires that the vehicle is driving at a low and constant speed of 240 M/h. Although it can be controlled by the current technology, the stability of the vehicle may be difficult to maintain. Therefore, the cost for using the high-pressure water blasting removal is relatively higher.

All referenced patents, applications, and literatures are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply. The disclosed embodiments may seek to satisfy one or more of the above-mentioned desires. Although the present embodiments may obviate one or more of the above-mentioned desires, it should be understood that some aspects of the embodiments might not necessarily obviate them.

### BRIEF SUMMARY OF THE DISCLOSURE

In a general implementation, the laser cleaning system comprises a laser cleaning device, comprising: a laser rubber-removal assembly comprising a laser generator, a laser ejector communicated with a laser generator, and a position adjustor slidably connected with the laser ejector; and a recycling assembly comprising a vacuum collector communicated with a recycling processing device; wherein the laser ejector is arranged on a loading assembly through the position adjustor; wherein the laser generator is configured to generate laser beams to remove rubber residues and the position adjustor is configured to adjust locations of the laser ejector.

In another aspect combinable with the general implementation, the vacuum collector is configured to collect the rubber residues and the recycling processing device is configured to granulate the collected rubber residues.

In another aspect combinable with the general implementation, the position adjustor comprises an X-axis adjustor connected with the loading assembly, a Y-axis adjustor vertically arranged with respect to the X-axis adjustor, and a Z-axis adjustor vertically arranged with respect to a plane defined by the X-axis adjustor and the Y-axis adjustor, wherein the Z-axis adjustor is connected with the laser ejector.

In another aspect combinable with the general implementation, the vacuum collector comprises a recycling unit arranged on the loading assembly and configured to collect the rubber residues.

In another aspect combinable with the general implementation, the recycling processing device comprises a granulating assembly communicated/connected with the vacuum collector and a weighing and packaging assembly symmetrically arranged with respect to the granulating assembly.

In another aspect combinable with the general implementation, the laser cleaning system further comprises a positioning assembly connected with the loading assembly and the position adjustor and located below a main body of a driving system, wherein the positioning assembly is configured to detect the positions of the rubber residues and control the position adjustor to activate movements of the laser ejector.

In another aspect combinable with the general implementation, the laser cleaning system further comprises a driving assembly connected with the laser cleaning device, wherein the driving assembly comprises a main body, a control unit arranged on the main body, and a power supply assembly arranged on the main body, wherein the loading assembly is slidably connected with the main body.

In another aspect combinable with the general implementation, the loading assembly comprises a first loading unit slidably connected with the main body and a second loading unit rotatably connected with the first loading unit, wherein the laser ejector is arranged on the second loading unit through the position adjustor.

In another aspect combinable with the general implementation, the driving assembly further comprises a turnover assembly connected with the second loading unit, wherein the turnover assembly is operated between a storage position and an operating position.

In another aspect combinable with the general implementation, the laser rubber-removal assembly and the recycling assembly are placed on the main body of the driving system.

In another aspect combinable with the general implementation, the driving assembly further comprises a cooling device arranged in alignment with the laser generator and configured to cool down the laser generator.

In another aspect combinable with the general implementation, the recycling assembly further comprises a dust filtering device connected with the vacuum collector and configured to filter the collected rubber residues, wherein the vacuum collector is located between the dust filtering device and the recycling processing device.

Another aspect of the embodiment is directed to a laser cleaning method comprising steps of moving a laser ejector of a laser rubber-removal assembly communicated with a laser generator towards rubber residues by sliding a position adjustor of the laser rubber-removal assembly located on a loading assembly;

removing the rubber residues by laser beams generated by the laser generator of a laser rubber-removal assembly and radiated from the laser ejector;

collecting the rubber residues by a vacuum collector of a recycling assembly; and

granulating the collected rubber residues by a recycling processing device of a recycling assembly connected with the vacuum collector.

Among the many possible implementations of the laser cleaning method, the position adjustor comprises an X-axis adjustor connected with the loading assembly, a Y-axis adjustor vertically arranged with respect to the X-axis adjustor, and a Z-axis adjustor vertically arranged with respect to a plane defined by the X-axis adjustor and the Y-axis adjustor, wherein the Z-axis adjustor is connected with the laser ejector.

Further, it is contemplated that the vacuum collector comprises a recycling unit arranged on a first loading unit of the loading assembly and configured to collect the rubber residues.

In the alternative, the recycling processing device comprises a granulating assembly connected with the vacuum collector and a weighing and packaging assembly symmetrically arranged with respect to the granulating assembly.

It is still further contemplated that the laser cleaning method further comprises detecting positions of rubber residues by a positioning assembly of a driving assembly.

It is still further contemplated that the laser cleaning method further comprises operating a turnover assembly of a driving assembly connected with a second loading unit between a storage position and an operating position.

It is still further contemplated that the laser cleaning method further comprises cooling down the laser generator by a cooling device of a driving assembly, wherein the cooling device is arranged in alignment with the laser generator.

It is still further contemplated that the laser cleaning method further comprises filtering the collected rubber residues by a dust filtering device of the recycling assembly, wherein the vacuum collector is located between the dust filtering device and the recycling processing device.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above and below as acting in certain combinations and even initially claimed as such, one or more features from a claimed combination can in some cases be excised from the combination, and the claimed combination may be directed to a subcombination or variation of a subcombination.

A number of implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

It should be noted that the drawing figures may be in simplified form and might not be to precise scale. In reference to the disclosure herein, for purposes of convenience and clarity only, directional terms such as top, bottom, left, right, up, down, over, above, below, beneath, rear, front, distal, and proximal are used with respect to the accompanying drawings. Such directional terms should not be construed to limit the scope of the embodiment in any manner.

FIG. 1 is a perspective view of a laser cleaning system according to an aspect of the embodiment.

FIG. 2 is an exploded view of the laser cleaning system of FIG. 1 according to an aspect of the embodiment.

FIG. 3 is a perspective view of a loading assembly and a position adjustor according to an aspect of the embodiment.

FIG. 4 is a perspective view of a granulating assembly of a recycling assembly according to an aspect of the embodiment.

FIG. 5 is a perspective view of a turnover assembly and a main body according to an aspect of the embodiment.

FIG. 6 is a perspective view of an installation assembly according to an aspect of the embodiment.

FIG. 7 is a block diagram of a laser cleaning method according to an aspect of the embodiment.

### DETAILED DESCRIPTION OF THE EMBODIMENTS

The different aspects of the various embodiments can now be better understood by turning to the following detailed description of the embodiments, which are presented as illustrated examples of the embodiments defined in the claims. It is expressly understood that the embodiments as defined by the claims may be broader than the illustrated embodiments described below.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

It shall be understood that the term “means,” as used herein, shall be given its broadest possible interpretation in accordance with 35 U.S.C., Section 112(f). Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

Unless defined otherwise, all technical and position terms used herein have the same meaning as commonly understood by one of ordinary skill in the art to which the invention pertains. Although many methods and materials similar, modified, or equivalent to those described herein can be used in the practice of the present invention without undue experimentation, the preferred materials and methods are described herein. In describing and claiming the present invention, the following terminology will be used in accordance with the definitions set out below.

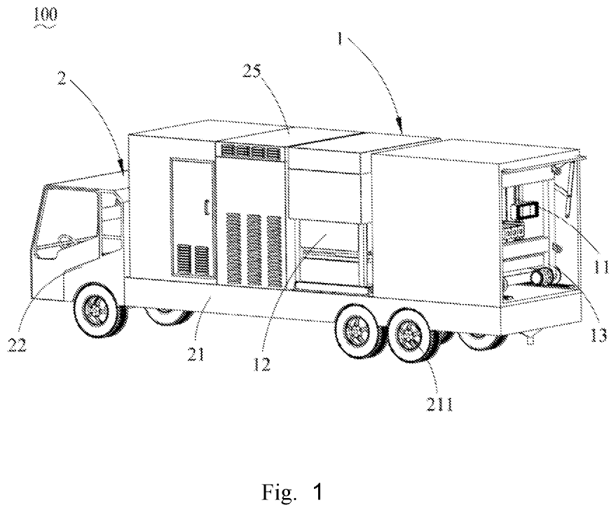

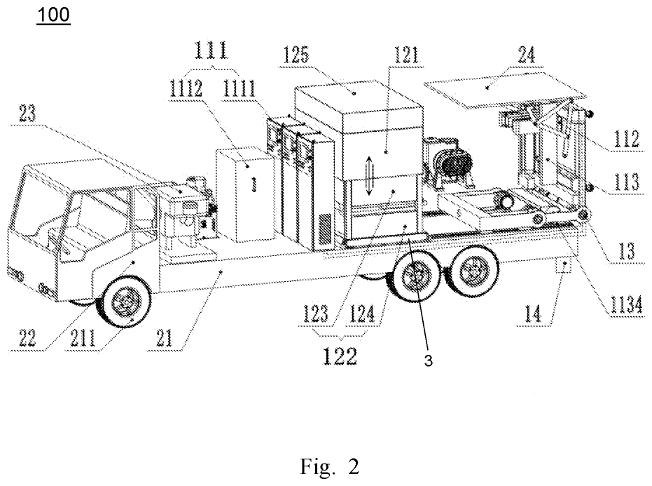

FIGS. 1-2 generally depict a laser cleaning system 100 according to an aspect of the embodiment.

Referring to FIG. 1, the laser cleaning system 100 may be utilized to clean a surface of an object or to remove rubber residues on the ground surface, and may be utilized to recycle the removed rubber residues.

In some embodiments, the laser cleaning system 100 comprises a laser cleaning device 1 configured to remove and recycle rubber residues and a driving assembly 2 configured to carry or support the laser cleaning device 1 placed thereon.

Referring to FIGS. 1-2, in some embodiments, the laser cleaning device 1 comprises a laser rubber-removal assembly 11, a recycling assembly 12, and a loading assembly 13 configured to carry the laser rubber-removal assembly 11, wherein the laser rubber-removal assembly 11 may be connected with the driving assembly 2. The laser rubber-removal assembly 11 comprises a laser generator 111, a laser ejector 112 connected/communicated with the laser generator 111, and a position adjustor 113 connected with the laser ejector 112.

In some embodiments, the laser generator 111 may be configured to generate laser beams and the laser beams may be radiated to positions of rubber residues through the laser ejector 112. The laser generator 111 further comprises a laser-generating control unit 1111 and an air compressor 1112 in alignment with the laser-generating control unit 1111. For one example, the laser generator 111 may be a high-frequency and short-wavelength laser generator.

In some embodiments, the laser generator 111 may be frequency-adjustable and/or wavelength-adjustable laser generators. It should be understood that the above-described types of laser generators are exemplary and any other laser generators can be adopted in various embodiments of this disclosure.

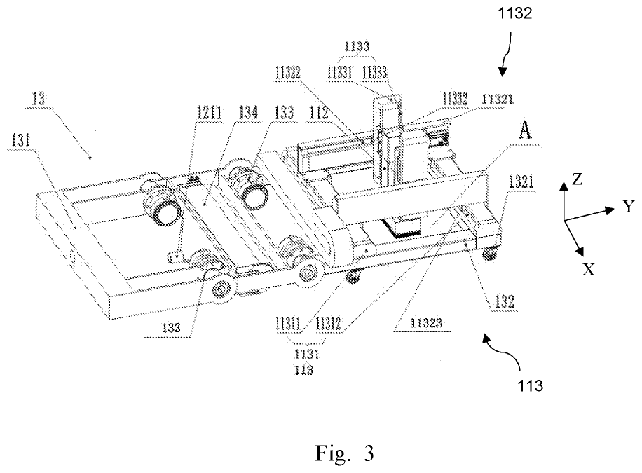

FIG. 3 generally depicts views of the loading assembly 13 and the position adjustor 113 according to an aspect of the embodiment.

Referring to FIG. 3, the laser ejector 12 may be arranged within the loading assembly 13 and cooperated with the position adjustor 113, wherein the position adjustor 113 may be activated to carry the laser ejector 112 for moving/sliding with respect to/along with the loading assembly 13, and in such a manner, the position of the laser ejector 112 may be moved to or away from the rubber residues. In other words, a distance between the laser ejector 112 and the rubber residues may be adjusted by moving the laser ejector 112 with respect to/along with the loading assembly 13 through operations of the position adjustor 113.

In some embodiments, the position adjustor 113 comprises an X-axis adjustor 1131 arranged on the loading assembly 13, a Y-axis adjustor 1132 vertically arranged on the X-axis adjustor 1131, and a Z-axis adjustor 1133 vertically arranged with respect to a plane A defined by the X-axis adjustor 1131 and the Y-axis adjustor 1132, wherein the Z-axis adjustor 1133 may be connected with the laser ejector 112.

In some embodiments, the position adjustor 113 comprises the X-axis adjustor 1131 arranged on the loading assembly 13, the Y-axis adjustor 1132 vertically arranged on and slidably connected with the X-axis adjustor 1131, and the Z-axis adjustor 1133 vertically arranged with the X-axis adjustor and/or the Y-axis adjustor and slidably connected with the Y-axis adjustor, wherein the Z-axis adjustor 1133 may be connected with the laser ejector 112.

In some embodiments, the X-axis adjustor 1131 comprises an X-axis slider 11311 and a first sliding slot 11312 formed on the X-axis slider 11311, wherein the Y-axis adjustor 1132 comprises a Y-axis slider 11321, a second sliding slot 11322 formed on the Y-axis slider 11321, and a second sliding block 11323 slidably engaged with the first sliding slot 11312 formed on the X-axis slider 11311, wherein the Z-axis adjustor 1133 comprises a Z-axis slider 11331, a third sliding block 11332 slidably engaged with the second sliding slot 11322, and a third sliding slot 11333 slidably engaged with the laser ejector 12. It should be noted that, in some embodiments, the laser ejector 112 may be connected with the Z-axis slider 11331. In such a way, the laser ejector 112 may be moved/slid towards the Z-axis by sliding the laser ejector 112 along with the Z-axis slider 11331. For one example, the laser ejector 112 may be moved towards the Y-axis by sliding the third sliding block 11332 of the Z-axis adjustor 1133 along the second sliding slot 11322. For another, the laser ejector 112 may be moved towards the X-axis by sliding the second sliding block 11323 along the first sliding slot 11312 of the X-axis slider 11311.

In some embodiments, the position adjustor 113 further comprises a servo motor 134 electrically communicated with the X-axis adjustor 1131, the Y-axis adjustor 1132, and the Z-axis adjustor 1133, wherein the servo motor 134 may be symmetrically arranged with respect to the X-axis slider 11311, the Y-axis slider 11321, and the Z-axis slider 11331. In such a known manner, the servo motor 134 may be utilized to activate the movements of the X-axis slider 11311, the Y-axis slider 11321, and the Z-axis slider 11331. In other words, the position adjustor 113 may be configured to adjust the locations of the laser ejector 112.

Continuing to FIGS. 1-2, the recycling assembly 12 may be connected with the driving assembly 2, wherein the recycling assembly 12 comprises a vacuum collector 121 and a recycling processing device 122 connected/communicated with the vacuum collector 121.

In some embodiments, the vacuum collector 121 comprises a vacuum generator (not shown in drawings) and a recycling unit 1211 (as shown in FIG. 3) arranged on the loading assembly 13 and configured to collect the rubber residues. The recycling unit 1211 may be connected with a first loading unit 131 of the loading assembly 13. For example, the vacuum collector 121 may be configured to collect the rubber residues.

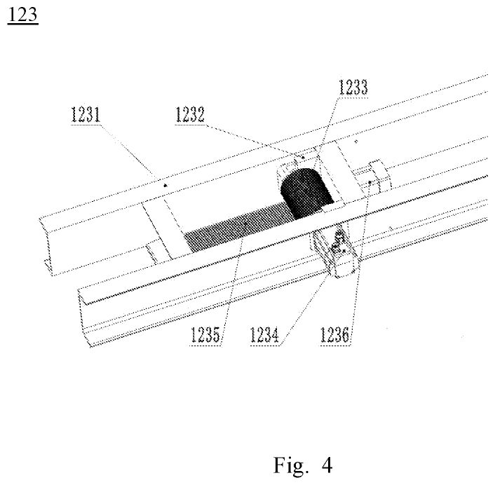

FIG. 4 generally depicts a granulating assembly 123 of the recycling processing device of an aspect of the embodiment.

Referring to FIGS. 2 and 4, the recycling processing device 122 may be configured to granulate the rubber residues collected by the vacuum collector 121.

In some embodiments, the recycling processing device 122 comprises the granulating assembly 123 communicated and connected with the vacuum collector 121 and a weighing and packaging assembly 124 symmetrically arranged with respect to the granulating assembly 123.

In some embodiments, the granulating assembly 123 may be located between the vacuum collector 121 and the weighing and packaging assembly 124.

Continuing to FIGS. 2 and 4, the granulating assembly 123 comprises at least one support frame 1231, a pair of damping frame 1232 arranged between a pair of the support frame 1231, and at least one granulating roller 1233 arranged between the pair of the support frame 1231 and the pair of the damping frame 1232, a driving motor 1234 electrically connected to the granulating roller 1233, a heating device 1235 communicated and/or connected with the granulating roller 1233, and a blowing device 1236 communicated and/or connected with the granulating roller 1233.

It should be understood that the above-described granulating assembly 123 is exemplary and any other granulating assemblies can be adopted in various embodiments of this disclosure.

In some embodiments, the rubber residues may be collected by the vacuum collector 121, and the collected rubber residues may be delivered to the granulating assembly 123. In such a manner, the collected rubber residues in the granulating assembly 123 may be heated by the heating device 1235 for performing the granulating process. The granulated rubber residues may be released from the granulating assembly 123 through the blowing device 1236.

In some embodiments, the granulating roller 1233 may be a stainless roller with a granulating size of 3.15 mm to 3.5 mm. In other words, the granulated rubber residues have a particle size of 3.15 mm to 3.5 mm. The surface roughness of the granulated rubber residues may be less than or equal to 0.4 μm. It should be noted that the granulated rubber residues having a particle size of 3.15 mm to 3.5 mm with the surface roughness of 0.4 μm may facilitate the granulated rubber residues (rubber residue granules) being released from the granulating assembly 123.

In some embodiments, the weighing and packaging assembly 124 may be configured to weigh and pack the granulated rubber residues released from the granulating assembly 123, wherein the weighing and packaging assembly 124 may comprise a weighing unit configured to weigh the granulated rubber residues released from the granulating assembly 123 and a packing unit configured to pack the weighed granulated rubber residues.

In some embodiments, the recycling assembly 12 further comprises a dust filtering device 125 communicated and/or connected with the vacuum collector 121 and communicated with the recycling processing device 122, wherein the dust filtering device 125 may be arranged on the vacuum collector 121, and the vacuum collector 121 may be located between the dust filtering device 125 and the recycling processing device 122. It should be noted that, in some embodiments, the dust filtering device 125 may be configured to filter the collected rubber residues.

In some embodiments, the collected rubber residues collected by the vacuum collector 121 may be delivered to the dust filtering device 125 to remove the dust containing in the collected rubber residues, and the filtered rubber residues may be delivered to the recycling processing device 122 to be granulated and be packed. In such a manner, the dust or impurity of the rubber residues may be removed by the dust filtering device 125 to increase the purity of the rubber residues.

In some embodiments, the rubber residues collected by the vacuum collector 12 may be delivered to the dust filtering device 125, and the collected rubber residues may be filtered by the dust filtering device 125 to form the filtered rubber residues, and then the filtered rubber residues may be delivered to the recycling processing device 122 to form the rubber residue granules. It should be noted that the dust filtering device 125 may be utilized to remove the dust or impurity of the rubber residues and improve the purity of the rubber in the rubber residues. The dust or impurity in the rubber residues may generate harmful smoke during the granulating and/or heating process provided by the granulating roller 1233 and the heating device 1235 respectively (as shown in FIG. 4).

Continuing to FIG. 3, the laser ejector 112, the position adjustor 113, and the recycling unit 1211 may be slidably connected on the driving assembly 2 (as shown in FIGS. 1 and 2) through the loading assembly 13. In the other words, the loading assembly 13 may be slidably connected with the position adjustor 113. In other words, the position adjustor 113 may be slidably connected with a main body 21 of the driving assembly 2 through the loading assembly 13, wherein the loading assembly 13 may be arranged on the main body 21.

In some embodiments, the loading assembly 13 comprises a first loading unit 131 slidably connected with a guiding track 1134 arranged on the main body 21 of the driving assembly 2 (as shown in FIG. 2) and a second loading unit 132 rotatably connected with the first loading unit 131, wherein the second loading unit 132 may be rotatably connected with the first loading unit 131 by a hydraulic swing motor 133, and in such a manner, the second loading unit 132 may be rotated with respect to the first loading unit 131 to form a predetermined angle.

In some embodiments, the first loading unit 131 may be slid along the guiding track 1134, and in such a manner, the first loading unit 131 may be slid on the main body 21 of the driving assembly 2 through the guiding track 1134.

In some embodiments, the position adjustor 113 and the laser ejector 112 may be arranged on and connected with the second loading unit 132, and the servo motor 134 and the recycling unit 1211 may be arranged on and connected with the first loading unit 131, wherein the first loading unit 131 may be arranged with respect to the second loading unit 132 to form a predetermined degree, wherein the predetermined degree may be 45 degrees (as shown in FIG. 2) to 180 degrees (as shown in FIG. 3).

In some embodiments, the position adjustor 113 may be operatively connected on a top side of the second loading unit 132, and at least one guiding wheel 1321 may be arranged on a bottom side of the second loading unit 132, wherein the top side of the second loading unit 132 may be opposite of the bottom side of the second loading unit 132. The second loading unit 132 may be sliding and supporting on the ground through the guiding wheels 1321 which is activated by the driving assembly 2 (as shown in FIG. 2), and in such a manner, the laser ejector 112 and the position adjustor 113 supported on the second loading unit 132 may be moved via the movements of the second loading unit 132.

Referring to FIGS. 1-2, in some embodiments, the laser cleaning device 1 further comprises a positioning assembly 14 arranged on the loading assembly 13 and connected with the position adjustor 113 and the loading assembly 13. For example, the positioning assembly 14 may be located below the loading assembly 13, the position adjustor 113, and the main body 2, wherein the positioning assembly 14 is configured to detect the positions of the rubber residues and control the position adjustor 113 to carry the movements of the laser ejector 12.

In some embodiments, the positioning assembly 14 may comprise a first positioning unit connected with the driving assembly 2 (as shown in FIG. 2), a second positioning unit connected with the second loading unit 132, and a third positioning unit connected with the position adjustor 113 to measure a height of the laser ejector 112, wherein the first positioning unit may comprise a camera to capture and/or recognize the locations of the rubber residues. For example, the first positioning unit may comprise a 500-pixel camera. The second positioning unit may comprise a camera to capture and/or recognize the locations of the rubber residues. For example, the second positioning unit may comprise a 500-pixel camera.

In some embodiments, the third positioning unit may comprise a rangefinder which may be configured to measure the height of the laser ejector 112, wherein the third positioning unit may be arranged at the same level of the laser ejector 112 to measure the height of the laser ejector 112. In other words, the height of the ejected laser beams radiated from the laser ejector 112 may be measured by the third positioning unit.

In some embodiments, the first positioning unit may be configured to locate the positions of the rubber residues and capture the images of the rubber residues, and the captured images of the rubber residues and the position information of the rubber residues may be delivered to the driving assembly 2 (as shown in FIG. 2), wherein the driving assembly 2 may provide an image recognition algorithm to recognize the positions of the rubber residues. According to the positions of the rubber residues, the X-axis adjustor 1131 and the Y-axis adjustor 1132 may be activated to move the laser ejector 112 to the positions of the rubber residues, and the Z-axis adjustor 1133 may be activated to adjust the height of the laser ejector 112. The height of the laser ejector 112 may be defined as a distance between the laser ejector 112 and the rubber residues deposited on the ground.

In some embodiments, the effective distance of the laser generator 111 may be 250 mm to 300 mm and the laser width of the laser generator 111 may be 900 mm. For one example, the driving assembly 2 (as shown in FIG. 2) may control the Z-axis adjustor 1133 (as shown in FIG. 3) to carry the laser ejector 112 to an effective distance of 260 mm (a distance between the laser ejector 112 and the rubber residues) to effectively remove the rubber residues on the ground.

Referring to the details of FIG. 2, the driving assembly 2 comprises the main body 21, a control unit 22 arranged on the main body 21, and a power supply assembly 23 arranged on the main body 21, wherein the control unit 22 may be configured to control the laser cleaning device 1 and the power supply assembly 23 may be configured to provide the power source for the laser cleaning device 1 (as shown in FIG. 1).

In some embodiments, the main body 21 may carry the laser cleaning device 1, wherein the laser cleaning device 1 may be placed on the main body 21 of the driving assembly 2. The driving assembly 2 may further comprise a moving unit 211 and a power unit configured to drive the moving unit 211. For example, the moving unit 211 may be driven by the power unit to carry the movements of the laser cleaning device 1 and the driving assembly 2.

In some embodiments, the main body 21 is a vehicle. For one example, the vehicle may be autonomous, wherein the control unit 22 may be arranged in the driver room. In such a manner, the control unit 22 may control the operations of the laser rubber-removal assembly 11 and the recycling assembly 12 at a constant speed. In some embodiments, the main body 21 may be moved at a constant speed through the moving unit 211.

It should be understood that the above-described main body 21 is exemplary and any other main bodies can be adopted in various embodiments of this disclosure.

In some embodiments, the control unit 22 may be connected with the laser rubber-removal assembly 11, the recycling assembly 12, and the loading assembly 13, and control the operations of the laser rubber-removal assembly 11, the recycling assembly 12, and the loading assembly 13.

In some embodiments, the control unit 22 may be a program logic control system. The power supply assembly 23 may be arranged aside from the laser cleaning device 1 to provide the power source for the laser cleaning device 1. For example, the power supply assembly 23 may be a set of rechargeable lithium batteries. In some embodiments, the power supply assembly 23 may be arranged next to the laser generator 111 to provide the power source for the laser generator 111.

As shown further details in FIG. 2, the driving assembly 2 may further comprise a turnover assembly 24 connected with the second loading unit 132, wherein the turnover assembly 24 is operated between a storage position and an operating position. In other words, the second loading unit 132 may be coupled with the turnover assembly 24. While the turnover assembly 24 is in the storage position, the laser ejector 112 and the recycling unit 1211 may be stored inside the main body 21 (as shown in FIG. 1), wherein the second loading unit 132 may be vertically arranged with respect to the first loading unit 131. While the turnover assembly 24 is in the operating position, the laser ejector 112 and the recycling unit 1211 may be exposed, wherein the second loading unit 132 may be arranged with respect to the first loading unit 131 to form a 180 degrees. For example, in the operating position, the first loading unit 131 may be parallelly arranged with the second loading unit 132.

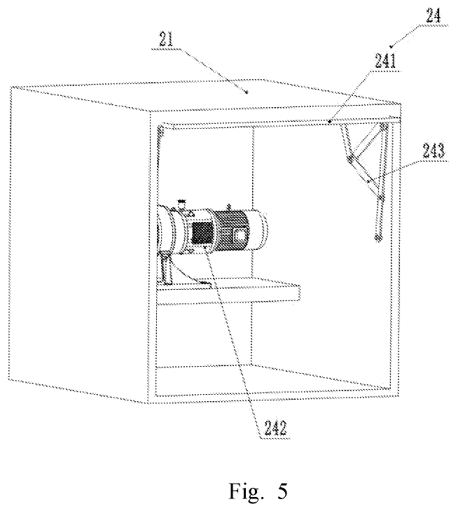

FIG. 5 generally depicts the turnover assembly 24 connected with the main body 21 according to an aspect of the embodiments.

In some embodiments, the turnover assembly 24 may comprise a turnover unit 241 connected to the main body 21, a turnover motor 242 electrically connected with the control unit 22, and at least one linking unit 243 connected between the main body 21 and the turnover unit 241. The linking unit 243 may be driven by the turnover motor 242 to carry the turnover movement of the turnover unit 241.

In some embodiments, while the turnover assembly 24 is in the storage position, the first loading unit 131 may be vertically arranged with the second loading unit 132, and the position adjustor 113 and the laser ejector 112 may be stored/located between the main body 21 and the turnover assembly 24 (as shown in FIG. 1 and FIG. 2).

In some embodiments, while the turnover assembly 24 is in the operating position, the first loading unit 131 may be sliding along the main body 21 through the guiding track 1134 (as shown in FIG. 2), and the second loading unit 132 may be clockwisely rotated which is activated by the hydraulic swing motor 133 until the guiding wheels 1231 (as shown in FIG. 3) touching on the ground (the first loading unit 131 may be parallelly arranged with the second loading unit 132). It should be noted that the laser ejector 112 and the recycling unit 1211 may be exposed to allow the laser beams radiating from the laser ejector 112 to apply on rubber residues. In some embodiments, while the turnover assembly 24 is operating from the storage position to the operating position, the Z-axis adjustor 1133 may be activated to move upwardly to carry the laser ejector 112 moving upwardly at the same time, and in such a manner, the laser ejector 112 may be avoided to be in contact with the ground.

In some embodiments, the driving assembly 2 may further comprise a cooling device 25 arranged in alignment with the laser generator 111 (as shown in FIGS. 1-3), wherein the cooling device 25 may be configured to cool down the laser generator 111 and the power supply assembly 23 arranged on the main body 21. In some embodiments, the laser generator 111 may be arranged between the cooling device 25 and the main body 21.

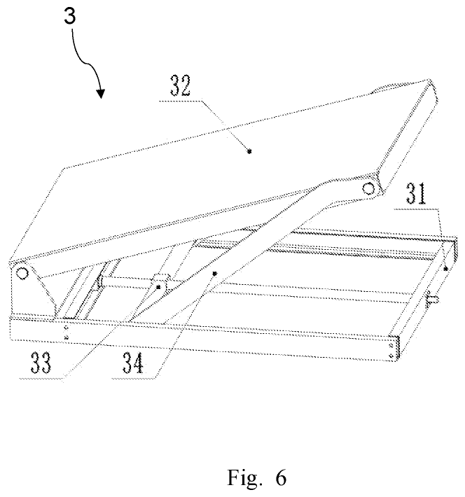

FIG. 6 generally depicts an installation assembly 3 of the laser cleaning system according to an aspect of the embodiments.

Referring to FIGS. 2 and 6, the laser cleaning system 100 may further comprise the installation assembly 3 arranged on the main body 21 and in alignment with the laser cleaning device 1. In some embodiments, the recycling processing device 122 may be positioned between the vacuum collector 121 and the installation assembly 3. In some embodiments, the installation assembly 3 may be arranged between the recycling processing device 122 and the main body 21. In some embodiments, the installation assembly 3 may be arranged below the recycling assembly 12 or the installation assembly 3 may be arranged in alignment with the recycling assembly 12.

In some embodiments, the installation assembly 3 further comprise a first supporting frame 31 connected with the main body 21 (as shown in FIG. 2), a supporting platform 32 operatively connected with the first supporting frame 31, a first middle supporting frame 33 slidably connected with the first supporting frame 31, and a second middle supporting frame 34 rotatably and pivotally connected with the supporting platform 32 and the first supporting frame 31.

In some embodiments, the installation assembly 3 may be placed on the ground, and the recycling assembly 12 placed on the installation assembly 3 may be inclinedly arranged with the ground having the supporting platform 32 being inclinedly arranged with the first supporting frame 31.

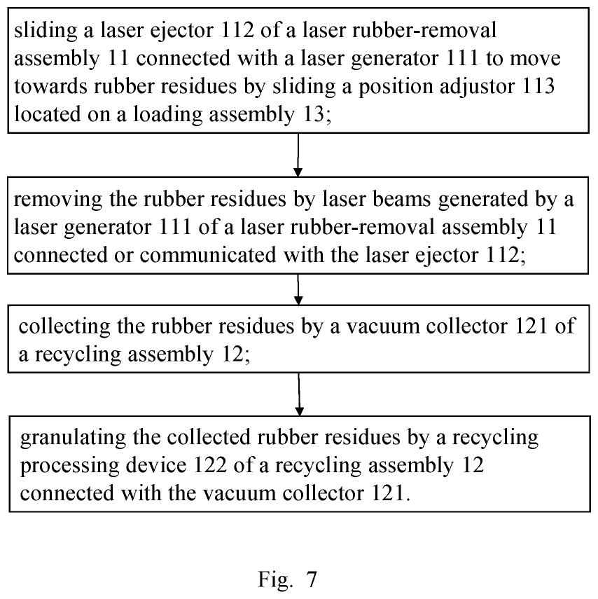

FIG. 7 generally depicts a laser cleaning method according to an aspect of the embodiments.

Referring to FIG. 7, the laser cleaning method comprises steps of:

sliding a laser ejector 112 of a laser rubber-removal assembly 11 connected with a laser generator 111 to move towards rubber residues by sliding a position adjustor 113 located on a loading assembly 13;

removing the rubber residues by laser beams generated by a laser generator 111 of a laser rubber-removal assembly 11 connected or communicated with the laser ejector 112;

collecting the rubber residues by a vacuum collector 121 of a recycling assembly 12; and

granulating the collected rubber residues by a recycling processing device 122 of a recycling assembly 12 connected with the vacuum collector 121.

In some embodiments, the step of sliding the laser ejector 112 of the laser rubber-removal assembly 11 comprises steps of: activating a positioning assembly 14 to detect positions of the rubber residues; activating the control unit 22 to decrease the speed of the movement of the laser ejector 112; and operating the turnover assembly 24 between an operating position and a storage position.

In some embodiments, the step of activating the positioning assembly 14 comprises a step of: activating a power supply assembly 23 of the driving assembly 2 arranged on the main body 21 to provide the power source.

In some embodiments, the step of removing the rubber residues comprises steps of: moving the laser ejector 112 at a constant speed along an S-shape route; and detecting the rubber residues by the positioning assembly 14 until all of the rubber residues are removed from the ground.

In some embodiments, the step of sliding the laser ejector of the laser rubber-removal assembly comprises steps of: decreasing the speed of a main body 21 having the laser cleaning device 1 placed thereon by the control unit 22; sliding a first loading unit 131 of the loading assembly 13 along the main body 21; and clockwisely rotating a second loading unit 132 of the loading assembly 13 until the guiding wheels 1321 being in contact with the ground.

In some embodiments, the step of collecting the rubber residues by the vacuum collector 121 of the recycling assembly 12 further comprises a step of: filtering the collected rubber residues by a dust filtering device 25 of the recycling assembly 12, wherein the dust filtering device 25 is communicated with the vacuum collector 121 and the recycling processing device 122.

In some embodiments, the step of granulating the collected rubber residues by the recycling processing device 122 of the recycling assembly 12 communicated with the vacuum collector 121 further comprises steps of: placing an installation assembly 3 having the recycling assembly 12 and the laser cleaning device 1 placed thereon on the ground; and adjusting a supporting platform 32 of the installation assembly 3 to be inclinedly arranged with the ground to facilitate the rubber residue granules blowing out of the recycling assembly 12.

In some embodiments, the main body 21 may be a vehicle, wherein the main body 21 may have a running speed of 360 m/h.

In some embodiments, the position adjustor 113 comprises an X-axis adjustor 1131 connected with the loading assembly 13, a Y-axis adjustor 1132 vertically arranged with respect to the X-axis adjustor 1131, and a Z-axis adjustor 1133 vertically arranged with respect to a plane defined by the X-axis adjustor 1131 and the Y-axis adjustor 1132, wherein the Z-adjustor 1133 may be connected with the laser ejector 112. In other words, the laser ejector 112 may be arranged on the second loading unit 132 through the position adjustor 113.

In some embodiments, the vacuum collector 121 may comprise a recycling unit 1211 arranged on and connected with the first loading unit 131 of the loading assembly 13 and configured to collect the rubber residues.

In some embodiments, the recycling processing device 122 comprises a granulating assembly 123 communicated and connected with the vacuum collector 121 and a weighing and packaging assembly 124 symmetrically arranged with respect to the granulating assembly 123.

In some embodiments, the step of sliding the laser ejector 112 of the laser rubber-removal assembly 12 connected with the laser generator 111 further comprises a step of: operating a turnover assembly 24 connected with a second loading unit 132 of the loading assembly 13 to operate between a storage position and an operating position.

In some embodiments, the step of granulating the collected rubber residues by the recycling processing device 122 of the recycling assembly 12 communicated with the vacuum collector 121 further comprises a step of cooling down the laser generator 111 by a cooling device 25, wherein the cooling device 25 is arranged in alignment with the laser generator 111. For example, the cooling device 25 may be arranged between the control unit 22 of the driving system 2 and the laser cleaning device 1.

Many alterations and modifications may be made by those having ordinary skill in the art without departing from the spirit and scope of the disclosed embodiments. Therefore, it must be understood that the illustrated embodiments have been set forth only for the purposes of example and that it should not be taken as limiting the embodiments as defined by the following claims. For example, notwithstanding the fact that the elements of a claim are set forth below in a certain combination, it must be expressly understood that the embodiment includes other combinations of fewer, more, or different elements, which are disclosed herein even when not initially claimed in such combinations.

Thus, specific embodiments and applications of the system and method for laser cleaning have been disclosed. It should be apparent, however, to those skilled in the art that many more modifications besides those already described are possible without departing from the disclosed concepts herein. The disclosed embodiments, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Insubstantial changes from the claimed subject matter as viewed by a person with ordinary skill in the art, now known or later devised, are expressly contemplated as being equivalent within the scope of the claims. Therefore, obvious substitutions now or later known to one with ordinary skill in the art are defined to be within the scope of the defined elements. The claims are thus to be understood to include what is specifically illustrated and described above, what is conceptually equivalent, what can be obviously substituted and also what essentially incorporates the essential idea of the embodiments. In addition, where the specification and claims refer to at least one of something selected from the group consisting of A, B, C . . . and N, the text should be interpreted as requiring at least one element from the group which includes N, not A plus N, or B plus N, etc.

The words used in this specification to describe the various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims therefore include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

What is claimed is:

1. A laser cleaning system, comprising:
a laser cleaning device, comprising:
a laser rubber-removal assembly comprising a laser generator, a laser ejector communicated with the laser generator, and a position adjustor slidably connected with the laser ejector; and
a recycling assembly comprising a vacuum collector and a recycling processing device communicated with the vacuum collector; wherein
the laser ejector is arranged on a loading assembly through the position adjustor; wherein
the laser generator is configured to generate laser beams to remove rubber residues and the position adjustor is configured to adjust locations of the laser ejector; wherein
the vacuum collector is configured to collect the removed rubber residues and the recycling processing device is configured to granulate the collected rubber residues.

2. The laser cleaning system of claim 1, wherein the recycling assembly further comprises a dust filtering device connected with the vacuum collector and configured to filter the collected rubber residues, wherein the vacuum collector is located between the dust filtering device and the recycling processing device.

3. The laser cleaning system of claim 1, wherein the vacuum collector comprises a recycling unit connected with a first loading unit of the loading assembly and configured to collect the rubber residues.

4. The laser cleaning system of claim 1, wherein the recycling processing device comprises a granulating assembly connected with the vacuum collector and a weighing and packaging assembly symmetrically arranged with respect to the granulating assembly.

5. The laser cleaning system of claim 1, further comprising a positioning assembly arranged on a bottom side of a main body of a driving system, wherein the loading assembly is arranged on a top side of the main body of the driving system which is opposite of the bottom side, wherein the positioning assembly is configured to detect positions of the rubber residues and control the position adjustor to carry movements of the laser ejector.

6. The laser cleaning system of claim 1, further comprising:
a driving assembly connected with the laser cleaning device; wherein
the driving assembly comprises a main body, a control unit arranged on the main body, and a power supply assembly arranged on the main body; wherein
the loading assembly is slidably connected with the main body.

7. The laser cleaning system of claim 6, wherein the loading assembly comprises a first loading unit slidably connected with the main body and a second loading unit rotatably connected with the first loading unit, wherein the laser ejector is arranged on the second loading unit through the position adjustor.

8. The laser cleaning system of claim 6, wherein the driving assembly further comprises a turnover assembly connected with the second loading unit, wherein the turnover assembly is operated between a storage position and an operating position.

9. The laser cleaning system of claim 6, wherein the laser rubber-removal assembly and the recycling assembly are placed on the main body of the driving system.

10. The laser cleaning system of claim 1, further comprising a cooling device arranged in alignment with the laser generator and configured to cool down the laser generator.

11. The laser cleaning system of claim 1, wherein the position adjustor comprises an X-axis adjustor connected with the loading assembly, a Y-axis adjustor vertically arranged on and slidably connected with the X-axis adjustor, and a Z-axis adjustor vertically arranged on and slidably connected with the Y-axis adjustor, wherein the Z-axis adjustor is connected with the laser ejector.

12. The laser cleaning system of claim 1, wherein the loading assembly comprises a first loading unit and a second loading unit rotatably connected with the first loading unit, wherein the first loading unit is vertically arranged with the second loading unit in a storage position and the first loading unit is parallelly arranged with the second loading unit in an operating position.

13. A laser cleaning method for a laser cleaning system, comprising steps of:
sliding a laser ejector of a laser rubber-removal assembly which is communicated with a laser generator towards rubber residues by sliding a position adjustor of the laser rubber-removal assembly located on a loading assembly;
removing the rubber residues by laser beams generated by the laser generator of a laser rubber-removal assembly;
collecting the removed rubber residues by a vacuum collector of a recycling assembly;
and
granulating the collected rubber residues by a recycling processing device of a recycling assembly connected with the vacuum collector.

14. The laser cleaning method of claim 13, wherein the vacuum collector comprises a recycling unit arranged on a first loading unit of the loading assembly and configured to collect the rubber residues.

15. The laser cleaning method of claim 13, wherein the recycling processing device comprises a granulating assembly connected with the vacuum collector and a weighing and packaging assembly symmetrically arranged with the granulating assembly.

16. The laser cleaning method of claim 13, further comprising detecting positions of rubber residues by a positioning assembly.

17. The laser cleaning method of claim 13, further comprising operating a turnover assembly of a driving assembly which is connected with a second loading unit between a storage position and an operating position.

18. The laser cleaning method of claim 13, further comprising cooling down the laser generator by a cooling device, wherein the cooling device is arranged in alignment with the laser generator.

19. The laser cleaning method of claim 13, wherein the position adjustor comprises an X-axis adjustor connected with the loading assembly, a Y-axis adjustor vertically arranged on and slidably connected with the X-axis adjustor, and a Z-axis adjustor vertically arranged on and slidably connected with the Y-axis adjustor, wherein the Z-axis adjustor is connected with the laser ejector.

20. The laser cleaning method of claim 13, further comprising filtering the collected rubber residues by a dust filtering device of the recycling assembly, wherein the vacuum collector is located between the dust filtering device and the recycling processing device.
